(19) United States
(12) Patent Application Publication
(10) Pub. No.: US 2026/0110580 A1
(43) Pub. Date: Apr. 23, 2026

(54) PROTECTIVE SHELL FOR MULTI-POINT TEMPERATURE MEASURING DEVICE AND MULTI-POINT TEMPERATURE MEASURING DEVICE

(71) Applicant: TECHIDEA PTY LTD, NSW (AU)

(72) Inventors: Feng SU, NSW (AU); Rongze SUN, NSW (AU); Enli SU, NSW (AU)

(73) Assignee: TECHIDEA PTY LTD, NSW (AU)

(21) Appl. No.: 19/276,673

(22) Filed: Jul. 22, 2025

(30) Foreign Application Priority Data
Oct. 21, 2024 (CN) 202411467345.8

(51) Int. Cl. G01K 1/12; G01K 1/10; G01K 1/16; G01K 3/14

(52) U.S. Cl. CPC G01K 1/12; G01K 1/10; G01K 1/16; G01K 3/14

(57) ABSTRACT

The present disclosure provides a protective shell for a multi-point temperature measuring device and a multi-point temperature measuring device. The protective shell includes: a shell body, with one end connected to a connecting base and the other end extending away from the connecting base. A cross-sectional area of an end of the shell body close to the connecting base is larger than a cross-sectional area of the end of the shell body away from the connecting body; the shell body is provided with a plurality of channels for extending temperature measuring elements; and ends of any two of the plurality of channels away from the connecting base are at different distances from the connecting base. The non-interfering channels ensure proper operation of the temperature measuring elements. The simple structure facilitates disassembly and replacement, enabling accurate and fast temperature detection at different positions.

### CROSS-REFERENCE TO RELATED APPLICATIONS

This application claims priority to Chinese Patent Application No. 202411467345.8 filed on Oct. 21, 2024. The disclosure of the above-referenced application is hereby incorporated by reference in its entirety.

### BACKGROUND

Temperature is a physical parameter that reflects the thermal state of an object. In human society, temperature is closely related to various sectors, including industry, agriculture, commerce, scientific research, national defense, medicine, and environmental protection. For example, in industrial automated production processes, temperature measurement points typically account for approximately half of all measurement points in terms of quantity.

In current temperature measurement methods, a temperature measuring element is installed in a protective shell to accommodate temperature measurement under harsh working conditions such as high temperature, wear, corrosion, and high flow velocity. Due to the large number of temperature measurement points, multi-point temperature measuring devices are commonly employed. With increasingly stringent digital monitoring requirements and the demands of special working conditions, the operating environments in critical areas of industries such as chemical, petrochemical, and nuclear power are becoming more complex, which makes temperature control during equipment operation more rigorous. As a result, temperature control during equipment operation is becoming more rigorous, with increasingly higher requirements being placed on temperature measurement accuracy, thermal response time, and service life. In existing multi-point temperature measuring devices, the protective shell is designed with a relatively large inner diameter to ensure proper installation of multiple temperature measuring elements inserted at a single temperature measurement port with considerable insertion depth. Although such a large inner diameter design solves the problem of difficult installation, the relatively large gap between the temperature measuring elements and the inner wall of the shell results in low thermal transfer efficiency. Moreover, after prolonged use, multiple temperature measuring elements may shift, interfere with each other, and become entangled, causing temperature signal crosstalk. When a certain temperature measuring element fails, it is impossible to accurately identify the faulty component, complicating replacement. As a result, the temperature measuring element in the shell cannot accurately and rapidly measure the temperature of the part to be measured, leading to low measurement accuracy and prolonged thermal response time.

Therefore, there is an urgent need for a protective shell for a multi-point temperature measuring device, as well as a multi-point temperature measuring device, which features a simple structure, faster thermal response, and higher temperature measurement accuracy, so as to address the above problems.

In view of the above, the present application is hereby submitted.

### SUMMARY

The present disclosure belongs to the field of multi-point temperature measurement technology, and specifically relates to a protective shell for a multi-point temperature measuring device and a multi-point temperature measuring device.

The technical problem to be solved by the present disclosure is to overcome the deficiencies of low temperature measurement accuracy and prolonged thermal response time in the existing art. The objective of the present disclosure is to provide a protective shell for a multi-point temperature measuring device.

Another objective of the present disclosure is to provide a multi-point temperature measuring device that employs the above protective shell.

In order to solve the above technical problems, the basic concept of the technical solution adopted by the present disclosure is: a protective shell for a multi-point temperature measuring device, including, a shell body, where an end of the shell body is connected to a connecting base, and the other end of the shell body extends in a direction away from the connecting base;
in a direction perpendicular to the extending direction of the shell body, a cross-sectional area of the end of the shell body close to the connecting base is larger than the cross-sectional area of the end of the shell body away from the connecting base; and
the shell body is provided with a plurality of channels for temperature measuring elements to extend; and ends of any two channels of the plurality of channels away from the connecting base have different distances from the connecting base.

According to an embodiment of the present disclosure, the shell body includes:
a first shell body, where an end of the first shell body is connected to the connecting base;
a second shell body, where an end of the second shell body is connected to an end of the first shell body away from the connecting base; and in a direction perpendicular to the extending direction of the shell body, a cross-sectional area of the second shell body is smaller than a cross-sectional area of the first shell body; and
a third shell body, where an end of the third shell body is connected to an end of the second shell body away from the first shell body; and in a direction perpendicular to the extending direction of the shell body, a cross-sectional area of the third shell body is smaller than the cross-sectional area of the second shell body.

According to an embodiment of the present disclosure, the protective shell further includes: a first connecting member, where the first connecting member is configured to connect the second shell body to the first shell body;
an end of the first connecting member close to the first shell body is at least partially inserted into the first shell body, and an end of the first connecting member close to the second shell body is provided with a first receiving groove; and
the second shell body is partially inserted into the first receiving groove.

According to an embodiment of the present disclosure, in a direction perpendicular to the extending direction of the shell body, a cross-sectional area of the end of the first connecting member away from the first shell body is greater than or equal to the cross-sectional area of the first shell body.

According to an embodiment of the present disclosure, the protective shell further includes:
a second connecting member, where the second connecting member is configured to connect the third shell body to the second shell body;
an end of the second connecting member close to the second shell body is at least partially inserted into the second shell body, and an end of the second connecting member close to the third shell body is provided with a second receiving groove; and
the third shell body is partially inserted into the second receiving groove.

According to an embodiment of the present disclosure, in a direction perpendicular to the extending direction of the shell body, a cross-sectional area of the end of the second connecting member away from the second shell body is greater than or equal to the cross-sectional area of the second shell body.

According to an embodiment of the present disclosure, the first shell body, the second shell body, and the third shell body are all internally hollow columnar structural members, where the third shell body is in communication with the first shell body and the second shell body; and
the temperature measuring element includes a first temperature measuring element, a second temperature measuring element, and a third temperature measuring element provided in parallel with each other, and ends of the first temperature measuring element, the second temperature measuring element, and the third temperature measuring element close to the connecting base are all disposed in the connecting base.

The channel includes:
a first channel, where the first channel is provided on the first connecting member and extends through the first connecting member; a plurality of the first channels are provided, and some of the first channels in the plurality of the first channels are in communication with the second shell body; the other end of the first temperature measuring element is disposed in the first channel; and a portion of the first temperature measuring element extends out of the shell body through the first channel; and
a second channel, where the second channel is provided on the second connecting member and extends through the second connecting member; the second channel is in communication with the first channel; a plurality of the second channels are provided, and some of the second channels in the plurality of the second channels are in communication with the third shell body; the other end of the second temperature measuring element is disposed in the second channel, and a portion of the second temperature measuring element extends out of the shell body through the second channel; the third temperature measuring element passes through the first shell body, the first connecting member, the second shell body, the second connecting member, and the third shell body; and a portion of the other end of the third temperature measuring element extends out of the third shell body of the shell body.

According to an embodiment of the present disclosure, the protective shell further includes: a guide tube, where the guide tube is configured to hold and guide the temperature measuring element extending out of the shell body.

The guide tube includes:
a first guide tube, where the first guide tube is disposed in the first shell body and the first connecting member, and an end of the first guide tube is connected to the connecting base, and the other end of the first guide tube is at least partially disposed in the first channel;
a second guide tube, where the second guide tube is disposed in the first shell body, the first connecting member, the second shell body, and the second connecting member, and an end of the second guide tube is connected to the connecting base, and the other end of the second guide tube is at least partially disposed in the second channel; and
a third guide tube, where the third guide tube is disposed in the first shell body, the first connecting member, the second shell body, the second connecting member, and the third shell body, and an end of the third guide tube is connected to the connecting base, and the other end of the third guide tube is at least partially disposed in the third shell body.

According to an embodiment of the present disclosure, the protective shell further includes: a heat-conducting component, where the heat-conducting component is a cap-shaped structural member made of a material with high thermal conductivity.

The heat-conducting component includes:
a first heat-conducting component, where an inner diameter of the first heat-conducting component matches an outer diameter of the first temperature measuring element; the end of the first temperature measuring element away from the connecting base is at least partially attached to an inner wall of the first heat-conducting component; and the first heat-conducting component is partially inserted into the first channel;
a second heat-conducting component, where an inner diameter of the second heat-conducting component matches an outer diameter of the second temperature measuring element; the end of the second temperature measuring element away from the connecting base is at least partially attached to the inner wall of the second heat-conducting component; and the second heat-conducting component is partially inserted into the second channel; and
a third heat-conducting component, where an inner diameter of the third heat-conducting component matches an outer diameter of the third temperature measuring element; the end of the third temperature measuring element away from the connecting base is at least partially attached to the inner wall of the third heat-conducting component; and the third heat-conducting component is partially inserted into an end of the third shell body away from the second connecting member.

The present disclosure further provides a multi-point temperature measuring device applied with the above-mentioned protective shell. The multi-point temperature measuring device includes: a temperature measuring element, where the temperature measuring element is disposed in the protective shell;
an end of the temperature measuring element is disposed in a connecting base, and the other end of the temperature measuring element is attached to a part to be measured;
the temperature measuring element includes a first temperature measuring element, a second temperature measuring element, and a third temperature measuring element provided in parallel with each other;
the first temperature measuring element is disposed in a first guide tube and a first heat-conducting component;
the second temperature measuring element is disposed in a second guide tube and a second heat-conducting component; and
the third temperature measuring element is disposed in a third guide tube and a third heat-conducting component.

By adopting the above technical solution, the present disclosure has the following beneficial effects compared with the existing art:
1) In the present disclosure, by providing a plurality of non-interfering channels, normal operation of the temperature measuring elements is ensured. The structure is simple, facilitating the disassembly and replacement of individual components, enabling the detection of temperature measurement points at different positions, with higher measurement accuracy and faster thermal response.
2) In the present disclosure, by providing a shell body as an assembly of multiple components, the length of the shell body can be adjusted as needed, thereby enabling detection of different temperature measuring points (parts to be measured).

The specific embodiments of the present disclosure are further described in detail below with reference to the drawings.

### BRIEF DESCRIPTION OF DRAWINGS

The drawings form a part of the present disclosure and are provided to facilitate a further understanding of the present disclosure. The exemplary embodiments of the present disclosure and their descriptions are intended to illustrate, but not to limit, the scope of the present invention. It is evident that the drawings described below are merely some embodiments of the present disclosure, and those skilled in the art can derive other drawings from these drawings without the exercise of creative efforts. Among the figures:

FIG. 1 is a schematic diagram of a structure of a protective shell for a multi-point temperature measuring device according to an embodiment of the present disclosure.

FIG. 2 is a schematic diagram of a structure of a multi-point temperature measuring device applied with a protective shell according to an embodiment of the present disclosure.

Description of main components in the figure:

1. shell body; 11. channel; 111. first channel; 112. second channel; 12. first shell body; 13. second shell body; 14. third shell body; 15. first connecting member; 16. first receiving groove; 17. second connecting member; 18. second receiving groove; 2. connecting base; 3. temperature measuring element; 31. first temperature measuring element; 32. second temperature measuring element; 33. third temperature measuring element; 4. guide tube; 41. first guide tube; 42. second guide tube; 43. third guide tube; 5. heat-conducting component; 51. first heat-conducting component; 52. second heat-conducting component; 53. third heat-conducting component.

It should be noted that these drawings and textual descriptions are not intended to limit the scope of the present disclosure in any way, but are provided to illustrate the concept of the present disclosure to those skilled in the art by reference to specific embodiments.

### DETAILED DESCRIPTION

In order to make the objectives, technical solutions, and advantages of the embodiments of the present disclosure more explicit, the technical solutions in the embodiments of the present disclosure will be explicitly and completely described below with reference to the drawings of the embodiments of the present disclosure. The following embodiments are provided to illustrate, rather than limit, the scope of the present disclosure.

In the description of the present disclosure, it should be noted that terms such as “upper”, “lower”, “front”, “rear”, “left”, “right”, “vertical”, “inner” and “outer”, which indicate spatial or positional relationships, are based on the orientation or positional relationships shown in the drawings. These terms are only for convenience of description of the present disclosure and simplifying the description, and are not intended to indicate or imply that the referenced devices or components must have a specific orientation and be structured and operated at a specific orientation. Therefore, they should not be construed as limiting the present disclosure.

In the description of the present disclosure, it should be noted that, unless explicitly specified and limited, the terms “installation”, “link”, and “connection” shall be understood in a broad sense. For example, the connection may be a fixed connection, a detachable connection, or an integral connection; it may be a mechanical connection or an electrical connection; and it may be a direct connection or an indirect connection via an intermediate medium. Those of ordinary skill in the art can interpret the specific meanings of the above terms in the context of the present disclosure, depending on the specific situation.

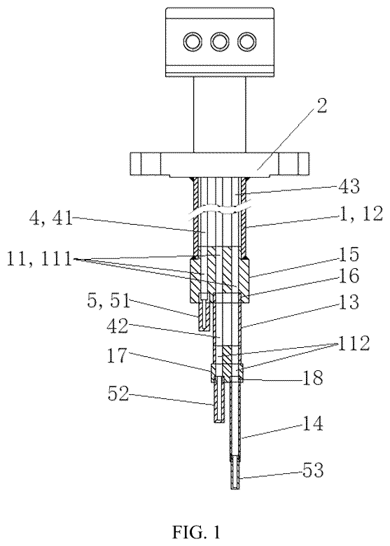

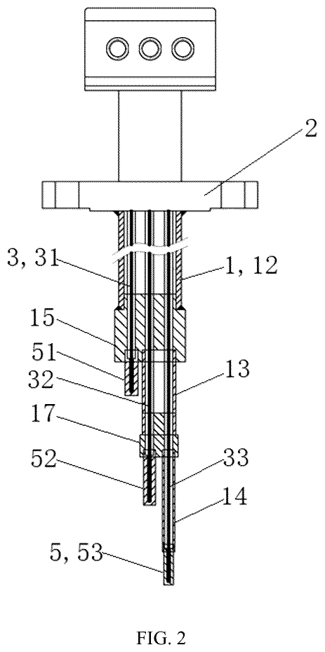

FIG. 1 of the present application discloses a protective shell for a multi-point temperature measuring device, and FIG. 2 of the present application discloses a multi-point temperature measuring device applied with a protective shell.

As shown in FIG. 1, a protective shell for a multi-point temperature measuring device according to the present disclosure includes: a shell body 1, where an end of the shell body 1 is connected to a connecting base 2, and the other end of the shell body 1 extends in a direction away from the connecting base 2;
in a direction perpendicular to the extending direction of the shell body 1, a cross-sectional area of the end of the shell body 1 close to the connecting base 2 is larger than the cross-sectional area of the end of the shell body 1 away from the connecting base 2; and
the shell body 1 is provided with a plurality of channels 11 for temperature measuring elements 3 to extend; and ends of any two channels 11 of the plurality of channels 11 away from the connecting base 2 have different distances from the connecting base 2.

In the present disclosure, by providing a plurality of non-interfering channels 11, normal operation of the temperature measuring elements 3 is ensured. The structure is simple, facilitating the disassembly and replacement of individual components, enabling the detection of temperature measurement points at different positions, with higher measurement accuracy and faster thermal response.

In a specific implementation of this embodiment, the temperature measuring element 3 is a thermocouple wire.

Referring to FIG. 1 and FIG. 2, in a specific implementation of this embodiment, the shell body 1 includes:
a first shell body 12, where an end of the first shell body 12 is connected to the connecting base 2;
a second shell body 13, where an end of the second shell body 13 is connected to an end of the first shell body 12 away from the connecting base 2; and in a direction perpendicular to the extending direction of the shell body 1, a cross-sectional area of the second shell body 13 is smaller than the cross-sectional area of the first shell body 12; and
a third shell 14, where an end of the third shell body 14 is connected to an end of the second shell body 13 away from the first shell body 12; and in a direction perpendicular to the extending direction of the shell body 1, a cross-sectional area of the third shell body 14 is smaller than the cross-sectional area of the second shell body 13.

That is the first shell body 12, the second shell body 13, and the third shell body 14 are connected in sequence.

In the present disclosure, by providing a shell body 1 as an assembly of multiple components, the length of the shell body 1 can be adjusted as needed, thereby enabling detection of different temperature measuring points (parts to be measured).

In another specific implementation of this embodiment, the shell body 1 further includes a fourth shell body and a fifth shell body sequentially connected after the first shell body 12, the second shell body 13, and the third shell body 14; and
the fourth shell body and the fifth shell body have shape features similar to those of the second shell body 13 and the third shell body 14, which are not repeated here.

In a specific implementation of this embodiment, the first shell body 12 is detachably connected to the connecting base 2 via flanges (not shown in the figures) connected by bolts.

In another specific implementation of this embodiment, the first shell body 12 is fixedly connected to the connecting base 2 by welding.

In a specific implementation of this embodiment, the first shell body 12, the second shell body 13, and the third shell body 14 are all columnar structural members; and
the columnar structural member can be a cylindrical structural member, a square structural member, or a truncated cone-shaped structural member.

In a specific implementation of this embodiment, the third shell body 14 and the second connecting member 17, the second connecting member 17 and the second shell body 13, the second shell body 13 and the first connecting member 15, and the first connecting member 15 and the first shell body 12 are all connected by connected by first inserting and then welding.

In another specific implementation of this embodiment, the third shell body 14 and the second connecting member 17, the second connecting member 17 and the second shell body 13, the second shell body 13 and the first connecting member 15, and the first connecting member 15 and the first shell body 12 are all connected via matching internal and external thread structures (not shown in the figures) provided at their respective ends.

In a specific implementation of this embodiment, in a direction perpendicular to the extending direction of the shell body 1, a cross-sectional area of an end of the first shell body 12, and/or the second shell body 13, and/or the third shell body 14 close to the connection base 2 is greater than a cross-sectional area of an end away from the connecting base 2.

That is the first shell body 12, and/or the second shell body 13, and/or the third shell body 14 is a truncated cone-shaped structural member or a truncated prism-shaped structural member.

In a specific implementation of this embodiment, the protective shell further includes: a first connecting member 15, where the first connecting member 15 is configured to connect the second shell body 13 to the first shell body 12;
an end of the first connecting member 15 close to the first shell body 12 is at least partially inserted into the first shell body 12, and an end of the first connecting member 15 close to the second shell body 13 is provided with a first receiving groove 16; and
the second shell body 13 is partially inserted into the first receiving groove 16.

In the present disclosure, the provision of the first connecting member 15 offers a connection interface for the first shell body 12 and the second shell body 13, thereby ensuring a smooth and stable connection between the first shell body 12 and the second shell body 13.

In a specific implementation of this embodiment, the second shell body 13 is a cylindrical structural member; and
the first receiving groove 16 is shaped to match an end of the second shell body 13 close to the first connecting member 15, so as to securely connect the second shell body 13 to the first connecting member 15.

In a specific implementation of this embodiment, in a direction perpendicular to the extending direction of the shell body 1, a cross-sectional area of the end of the first connecting member 15 away from the first shell body 12 is greater than or equal to the cross-sectional area of the first shell body 12.

In a specific implementation of this embodiment, in the direction parallel to the extending direction of the shell body 1, the first connecting member 15 is a T-shaped structural member in a sectional view;
a small end of the first connecting member 15 (a small end of the T-shaped structural member) is at least partially inserted into the first shell body 12 to fix the first connecting member 15 on the first shell body 12; and
in a direction perpendicular to the extending direction of the shell body 1, a projected width of a large end of the first connecting member 15 (a large end of the T-shaped structural member, that is, the end of the first connecting member 15 away from the connecting base 2) is greater than or equal to the projected width of the first shell body 12.

In the present disclosure, by providing the first connecting member 15 with a well-defined boundary relative to the first shell body 12, disassembly and assembly are made more convenient.

In a specific implementation of this embodiment, the protective shell further includes:
a second connecting member 17, where the second connecting member 17 is configured to connect the third shell body 14 to the second shell body 13;
an end of the second connecting member 17 close to the second shell body 13 is at least partially inserted into the second shell body 13, and an end of the second connecting member 17 close to the third shell body 14 is provided with a second receiving groove 18; and
the third shell body 14 is partially inserted into the second receiving groove 18.

In the present disclosure, the provision of the second connecting member 17 offers a connection interface for the second shell body 13 and the third shell body 14, thereby ensuring a smooth and secure connection between the second shell body 13 and the third shell body 14.

In a specific implementation of this embodiment, the third shell body 14 is a cylindrical structural member; and
the second receiving groove 18 is shaped to match an end of the third shell body 14 close to the second connecting member 17, so as to securely connect the third shell body 14 to the second connecting member 17.

In a specific implementation of this embodiment, in a direction perpendicular to the extending direction of the shell body 1, a cross-sectional area of an end of the second connecting member 17 away from the second shell body 13 is greater than or equal to the cross-sectional area of the second shell body 13.

In a specific implementation of this embodiment, in a direction parallel to the extending direction of the shell body 1, the second connecting member 17 is a T-shaped structural member in a sectional view;
a small end of the second connecting member 17 (a small end of the T-shaped structural member) is at least partially inserted into the second shell body 13 to fix the second connecting member 17 on the second shell body 13; and
in a direction perpendicular to the extending direction of the shell body 1, a projected width of a large end of the second connecting member 17 (a large end of the T-shaped structural member, that is, the end of the second connecting member 17 away from the connecting base 2) is greater than or equal to the projected width of the second shell body 13.

In the present application, by providing the second connecting member 17 with a well-defined boundary relative to the first shell body 12, disassembly and assembly are made more convenient.

In a specific implementation of this embodiment, anti-slip washers (or anti-slip pads) are provided in the interlayer (the fitting surface where the two components are close to each other) at the connection portions (referring to the plug-in scheme) between the first shell body 12 and the first connecting member 15, the first connecting member 15 and the second shell body 13, the second shell body 13 and the second connecting member 17, and the second connecting member 17 and the third shell body 14, so as to further fasten the connection and prevent abnormal detachment of components.

It should be understood that the anti-slip washer can be sleeved over an end of a component, while the anti-slip pad can be adhered to the end of the component.

In a specific implementation of this embodiment, the anti-slip washer is sleeved over the end of the first connecting member 15 close to the first shell body 12; the anti-slip washer is sleeved over the end of the second shell body 13 close to the first connecting member 15; the anti-slip washer is sleeved over the end of the second connecting member 17 close to the second shell body 13; and the anti-slip washer is sleeved over the end of the third shell body 14 close to the second connecting member 17.

In a specific implementation of this embodiment, the anti-slip washer has a certain length (a length in the direction parallel to the extending direction of the shell body 1); for example, the length of the anti-slip washer is greater than or equal to half of a length of the third shell body 14 inserted into the second connecting member 17; and the same principle applies to the anti-slip washers provided on other components.

In a specific implementation of this embodiment, a side of the anti-slip washer away from the component on which it is sleeved is provided with an anti-slip protrusion; and
the anti-slip protrusion is a triangular protrusion or a trapezoidal protrusion.

In the present application, the provision of the anti-slip washer ensures the reliability of the connection between adjacent components.

In a specific implementation of this embodiment, the first shell body 12, the second shell body 13, and the third shell body 14 are all internally hollow columnar structures, and the third shell body 14 is in communication with the first shell body 12 and the second shell body 13;
the temperature measuring element 3 includes a first temperature measuring element 31, a second temperature measuring element 32, and a third temperature measuring element 33 provided in parallel with each other, and ends of the first temperature measuring element 31, the second temperature measuring element 32, and the third temperature measuring element 33 close to the connecting base 2 are all disposed in the connecting base 2; and
the channel 11 includes:
a first channel 111, wherein the first channel 111 is provided on the first connecting member 15 and extends through the first connecting member 15; a plurality of the first channels 111 are provided, and some of the first channels 111 in the plurality of first channels 111 are in communication with the second shell body 13; the other end of the first temperature measuring element 31 is disposed in the first channel 111; and a portion of the first temperature measuring element 31 extends out of the shell body 1 through the first channel 111; and
a second channel 112, where the second channel 112 is provided on the second connecting member 17 and extends through the second connecting member 17; the second channel 112 is in communication with the first channel 111; a plurality of the second channels 112 are provided, and some of the second channels 112 in the plurality of the second channels 112 are in communication with the third shell body 14; the other end of the second temperature measuring element 32 is disposed in the second channel 112, and a portion of the second temperature measuring element 32 extends out of the shell body 1 through the second channel 112; the third temperature measuring element 33 passes through the first shell body 12, the first connecting member 15, the second shell body 13, the second connecting member 17, and the third shell body 14; and a portion of the other end of the third temperature measuring element 33 extends out of the third shell body 14 of the shell body 1.

In the present disclosure, by providing the channel 11 with multiple sub-channels, multiple temperature measuring elements 3 can be provided in a spaced manner to avoid mutual interference or even entanglement among the temperature measuring elements.

In a specific implementation of this embodiment, three first channels 111 are provided, and two of the three first channels 111 are in communication with the second shell body 13;
the first temperature measuring element 31 extends out of the shell body 1 through one first channel 111 that is not in communication with the second shell body 13;
two second channels 112 are provided, both of the second channels 112 are in communication with the first channel 111; one of the two second channels 112 is in communication with the third shell body 14; the third temperature measuring element 33 passes through the third shell body 14 and extends out of the shell body 1 through the second channel 112 that is in communication with the third shell body 14; and
the second temperature measuring element 32 extends out of the shell body 1 through the second channel 112 that is not in communication with the third shell body 14.

In a specific implementation of this embodiment, a plurality of the first channels 111 are provided, and the plurality of the first channels 111 are circumferentially arranged; and
a plurality of the second channels 112 are provided, and the plurality of the second channels 112 are circumferentially arranged.

Referring to FIG. 1, in a specific implementation of this embodiment, the protective shell further includes: a guide tube 4, where the guide tube 4 is configured to hold and guide the temperature measuring element 3 extending out of the shell body 1; and
the guide tube 4 includes:
a first guide tube 41, where the first guide tube 41 is disposed in the first shell body 12 and the first connecting member 15, and an end of the first guide tube 41 is connected to the connecting base 2, and the other end of the first guide tube 41 is at least partially disposed in the first channel 111;
a second guide tube 42, where the second guide tube 42 is disposed in the first shell body 12, the first connecting member 15, the second shell body 13, and the second connecting member 17; and an end of the second guide tube 42 is connected to the connecting base 2, and the other end of the second guide tube 42 is at least partially disposed in the second channel 112; and
a third guide tube 43, where the third guide tube 43 is disposed in the first shell body 12, the first connecting member 15, the second shell body 13, the second connecting member 17, and the third shell body 14; and an end of the third guide tube 43 is connected to the connecting base 2, and the other end of the third guide tube 43 is at least partially disposed in the third shell body 14.

In the present disclosure, the provision of the guide tube 4 not only serves to guide the insertion of the temperature measuring element, but also functions to isolate adjacent temperature measuring elements, thereby ensuring the stability of their respective functions. When one or more temperature measuring elements fail, the provision of the guide also facilitates the replacement of components.

In another specific implementation of this embodiment, the third guide tube 43 is disposed in the first shell body 12, the first connecting member 15, the second shell body 13, and the second connecting member 17; an end of the third guide tube 43 is connected to the connecting base 2, and the other end of the third guide tube 43 is at least partially disposed in the second channel 112 of the second connecting member 17; and
an axial length (a length in a direction parallel to the extending direction of the shell body 1) of the second guide tube 42 is equal that of the third guide tube 43.

In a specific implementation of this embodiment, an axial length (in a direction parallel to the extending direction of the shell body 1) of the first guide tube 41 is less than or equal to a distance from an end face of the end of the first connecting member 15 away from the connecting base 2 to the connecting base 2.

In a specific implementation of this embodiment, an axial length (in a direction parallel to the extending direction of the shell body 1) of the second guide tube 42 is less than or equal to a distance from an end face of the end of the second connecting member 17 away from the connecting base 2 to the connecting seat 2.

In a specific implementation of this embodiment, an axial length (in a direction parallel to the extending direction of the shell body 1) of the third guide tube 43 is less than or equal to a distance from an end face of the end of the third shell body 14 away from the connecting base 2 to the connecting base 2.

In a specific implementation of this embodiment, an outer diameter of the first guide tube 41 is equal to or less than an inner diameter of the first channel 111;
the outer diameter of the second guide tube 42 is equal to or less than the inner diameter of the second channel 112; and
the outer diameter of the third guide tube 43 is equal to or less than the inner diameter of a hollow portion of the third shell body 14.

In a specific implementation of this embodiment, the inner diameter of the first channel 111 is equal to the inner diameter of the second channel 112.

In a specific implementation of this embodiment, outer diameters of the first guide tube 41, the second guide tube 42, and the third guide tube 43 are equal;
inner diameters of the first guide tube 41, the second guide tube 42, and the third guide tube 43 are equal; and
the first guide tube 41, the second guide tube 42, and the third guide tube 43 are all internally hollow cylindrical structural members.

Referring to FIG. 1, in a specific implementation of this embodiment, the protective shell further includes: a heat-conducting component 5, where the heat-conducting component 5 is a cap-shaped structural member (a barrel-shaped structural member with one side blocked and one side open) made of a material with high thermal conductivity; and
the heat-conducting component 5 includes:
a first heat-conducting component 51, wherein an inner diameter of the first heat-conducting component 51 matches an outer diameter of the first temperature measuring element 31; the end of the first temperature measuring element 31 away from the connecting base 2 is at least partially (at least partially refers to at least a part or the whole) attached to an inner wall of the first heat-conducting component 51; and the first heat-conducting component 51 is partially inserted into the first channel 111;
a second heat-conducting component 52, where an inner diameter of the second heat-conducting component 52 matches an outer diameter of the second temperature measuring element 32; the end of the second temperature measuring element 32 away from the connecting base 2 is at least partially attached to the inner wall of the second heat-conducting component 52; and the second heat-conducting component 52 is partially inserted into the second channel 112; and
a third heat-conducting component 53, where an inner diameter of the third heat-conducting component 53 matches an outer diameter of the third temperature measuring element 33; the end of the third temperature measuring element 33 away from the connecting base 2 is at least partially attached to the inner wall of the third heat-conducting component 53; and the third heat-conducting component 53 is partially inserted into an end of the third shell body 14 away from the second connecting member 17.

In the present disclosure, by providing the heat-conducting component 5, the heat-conducting component 5 is in contact with the temperature measuring element 3, and the heat-conducting component 5 touches the temperature measuring point and transfers heat to the temperature measuring element 3, thereby ensuring rapid temperature transmission.

In a specific implementation of this embodiment, the heat-conducting component 5 is a structural member made of metal material, such as copper, aluminum, silver, or platinum-rhodium alloy.

In a specific implementation of this embodiment, the first heat-conducting component 51 is partially inserted into the first channel 111 and sleeved over the first guide tube 41; another portion (the end away from the first connecting member 15) of the first heat-conducting component 51 extends out of the first channel 111;
the second heat-conducting component 52 is partially inserted into the second channel 112 and sleeved over the second guide tube 42; and another portion (the end away from the second connecting member 17) of the second heat-conducting component 52 extends out of the second channel 112.

In a specific implementation of this embodiment, the third heat-conducting component 53 is partially inserted into the third shell body 14 and sleeved over the third guide tube 43; and another portion (the end away from the third shell 14) of the third heat-conducting component 53 extends out of the third shell body 14.

In a specific implementation of this embodiment, inner diameters of the first channel 111 and the second channel 112 at ends close to the connecting base 2 is less than or equal to the inner diameters of the first channel 111 and the second channel 112 at the ends away from the connecting base 2.

It should be noted that when the present application describes a component (component A) being sleeved on another component (component B), the design can also be that the component B is sleeved over the component A (an inside/outside difference). For example, the above description states that the first heat-conducting component 51 is sleeved over the first guide tube 41, which can alternatively mean that the first heat-conducting component 51 is inserted into the first guide tube 41 (the first guide tube 41 is sleeved over the first heat-conducting component 51).

In another specific implementation of this embodiment, an outer diameter of the first heat-conducting component 51 is equal to an outer diameter of the first guide tube 41, and an axis of the first heat-conducting component 51 coincides with an axis of the first guide tube 41, and the end of the first heat-conducting component 51 extending into the first channel 111 abuts against the end of the first guide tube 41 away from the connecting base 2.

In a specific implementation of this embodiment, the protective shell further includes: a thermal insulation ring (not shown in the figures), and the thermal insulation ring is provided between the heat-conducting component 5 and the guide tube 4 (whether two ends of the two are sleeved together or abut against each other).

In the present disclosure, by providing the thermal insulation ring, the heat conducted by the heat-conducting component 5 is efficiently directed and transferred, reducing unnecessary heat loss, and ensuring the accuracy of temperature measurement while maintaining thermal response speed.

Referring to FIG. 2, the present disclosure further provides a multi-point temperature measuring device applied with the above-mentioned protective shell. The multi-point temperature measuring device includes: a temperature measuring element 3, where the temperature measuring element 3 is disposed in the protective shell;
an end of the temperature measuring element 3 is disposed in a connecting base 2, and the other end of the temperature measuring element 3 is attached to a part to be measured;
the temperature measuring element 3 includes a first temperature measuring element 31, a second temperature measuring element 32, and a third temperature measuring element 33 provided parallel to each other;
the first temperature measuring element 31 is disposed in a first guide tube 41 and a first heat-conducting component 51;
the second temperature measuring element 32 is disposed in a second guide tube 42 and a second heat-conducting component 52; and
the third temperature measuring element 33 is disposed in a third guide tube 43 and a third heat-conducting component 53.

In the present disclosure, by providing a plurality of temperature measuring elements, simultaneous detection of temperature at different temperature measuring points (temperature measuring positions) is achieved, and interference among the plurality of temperature measurements is avoided.

In a specific implementation of this embodiment, a length of the first temperature measuring element 31 is greater than a distance from an end face of an end of the first connecting member 15 away from the connecting base 2 to the connecting base 2;
a length of the second temperature measuring element 32 is greater than a distance from an end face of an end of the second connecting member 17 away from the connecting base 2 to connecting base 2; and
a length of the third temperature measuring element 33 is greater than a distance from an end face of an end of the third shell body 14 away from the connecting base 2 to the connecting base 2.

By applying a multi-point temperature measuring system provided in the present disclosure, high-precision and fast-response temperature measurement is achieved. When the temperature step reaches τ0.9, the thermal response time is less than 50 seconds, and when the temperature step reaches τ0.632, the thermal response time is less than 30 seconds, which meets the requirements of temperature measurement under special working conditions.

The above descriptions are merely preferred embodiments of the present disclosure and are not intended to limit the present disclosure in any form. Although the present disclosure has been disclosed through the above-mentioned preferred embodiments, it is not intended to limit the present disclosure. Any person skilled in the art can make some changes or modifications to equivalent embodiments based on the technical teachings disclosed above without departing from the scope of the technical solution of the present disclosure. The implementations in the above embodiments can also be further combined or replaced. Any simple modifications, equivalent changes, and modifications made to the above embodiments based on the technical essence of the present disclosure that do not deviate from the content of the technical solution of the present disclosure shall fall within the scope of the present disclosure.

What is claimed is:

1. A protective shell for a multi-point temperature measuring device, comprising, a shell body, wherein an end of the shell body is connected to a connecting base, and the other end of the shell body extends away from the connecting base;
in a direction perpendicular to an extending direction of the shell body, a cross-sectional area of an end of the shell body close to the connecting base is greater than a cross-sectional area of an end of the shell body away from the connecting base; and
the shell body is provided with a plurality of channels for temperature measuring elements to extend; and ends of any two channels of the plurality of channels away from the connecting base have different distances from the connecting base.

2. The protective shell for a multi-point temperature measuring device according to claim 1, wherein the shell body comprises:
a first shell body, wherein an end of the first shell body is connected to the connecting base;
a second shell body, wherein an end of the second shell body is connected to an end of the first shell body away from the connecting base; and in a direction perpendicular to the extending direction of the shell body, a cross-sectional area of the second shell body is smaller than a cross-sectional area of the first shell body; and
a third shell body, wherein an end of the third shell body is connected to an end of the second shell body away from the first shell body; and in a direction perpendicular to the extending direction of the shell body, a cross-sectional area of the third shell body is smaller than the cross-sectional area of the second shell body.

3. The protective shell for a multi-point temperature measuring device according to claim 2, further comprising: a first connecting member, wherein the first connecting member is configured to connect the second shell body to the first shell body;
an end of the first connecting member close to the first shell body is at least partially inserted into the first shell body, and an end of the first connecting member close to the second shell body is provided with a first receiving groove; and
the second shell body is partially inserted into the first receiving groove.

4. The protective shell for a multi-point temperature measuring device according to claim 3, wherein, in a direction perpendicular to the extending direction of the shell body, a cross-sectional area of an end of the first connecting member away from the first shell body is greater than or equal to the cross-sectional area of the first shell body.

5. The protective shell for a multi-point temperature measuring device according to claim 3, further comprising:
a second connecting member, wherein the second connecting member is configured to connect the third shell body to the second shell body;
an end of the second connecting member close to the second shell body is at least partially inserted into the second shell body, and an end of the second connecting member close to the third shell body is provided with a second receiving groove; and
the third shell body is partially inserted into the second receiving groove.

6. The protective shell for a multi-point temperature measuring device according to claim 5, wherein, in a direction perpendicular to the extending direction of the shell body, a cross-sectional area of an end of the second connecting member away from the second shell body is greater than or equal to the cross-sectional area of the second shell body.

7. The protective shell for a multi-point temperature measuring device according to claim 5, wherein the first shell body, the second shell body, and the third shell body are hollow columnar strucutures, and the third shell body is in communication with the first shell body and the second shell body;
the temperature measuring element comprises a first temperature measuring element, a second temperature measuring element, and a third temperature measuring element provided in parallel with each other, and ends of the first temperature measuring element, the second temperature measuring element, and the third temperature measuring element close to the connecting base are disposed in the connecting base; and
the channel comprises:
a first channel, wherein the first channel is provided on the first connecting member and extends through the first connecting member; a plurality of the first channels are provided, and some of the plurality of first channels are in communication with the second shell body; the other end of the first temperature measuring element is disposed in the first channel; and a portion of the first temperature measuring element extends out of the shell body through the first channel; and
a second channel, wherein the second channel is provided on the second connecting member and extends through the second connecting member; the second channel is in communication with the first channel; a plurality of the second channels are provided, and some of the plurality of the second channels are in communication with the third shell body; the other end of the second temperature measuring element is disposed in the second channel, and a portion of the second temperature measuring element extends out of the shell body through the second channel; the third temperature measuring element extends through the first shell body, the first connecting member, the second shell body, the second connecting member, and the third shell body; and a portion of the other end of the third temperature measuring element extends out of the third shell body of the shell body.

8. The protective shell for a multi-point temperature measuring device according to claim 7, further comprising: a guide tube, wherein the guide tube is configured to hold and guide the temperature measuring element to extend out of the shell body; and
the guide tube comprises:
a first guide tube, wherein the first guide tube is disposed in the first shell body and the first connecting member, and an end of the first guide tube is connected to the connecting base, and the other end of the first guide tube is at least partially disposed in the first channel;
a second guide tube, wherein the second guide tube is disposed in the first shell body, the first connecting member, the second shell body, and the second connecting member; and an end of the second guide tube is connected to the connecting base, and the other end of the second guide tube is at least partially disposed in the second channel; and
a third guide tube, wherein the third guide tube is disposed in the first shell body, the first connecting member, the second shell body, the second connecting member, and the third shell body; and an end of the third guide tube is connected to the connecting base, and the other end of the third guide tube is at least partially disposed in the third shell body.

9. The protective shell for a multi-point temperature measuring device according to claim 7, further comprising: a heat conducting component, wherein the heat-conducting component is a cap-shaped structural member made of a material with high thermal conductivity; and
the heat-conducting component comprises:
a first heat-conducting component, wherein an inner diameter of the first heat-conducting component matches an outer diameter of the first temperature measuring element; the end of the first temperature measuring element away from the connecting base is at least partially attached to an inner wall of the first heat-conducting component; and the first heat-conducting component is partially inserted into the first channel;
a second heat-conducting component, wherein an inner diameter of the second heat-conducting component matches an outer diameter of the second temperature measuring element; the end of the second temperature measuring element away from the connecting base is at least partially attached to an inner wall of the second heat-conducting component; and the second heat-conducting component is partially inserted into the second channel; and
a third heat-conducting component, wherein an inner diameter of the third heat-conducting component matches an outer diameter of the third temperature measuring element; the end of the third temperature measuring element away from the connecting base is at least partially attached to an inner wall of the third heat-conducting component; and the third heat-conducting component is partially inserted into an end of the third shell body away from the second connecting member.

10. A multi-point temperature measuring device, comprising the protective shell according to claim 1, wherein the multi-point temperature measuring device comprises: a temperature measuring element; wherein the temperature measuring element is disposed in the protective shell;
an end of the temperature measuring element is disposed in a connecting base, and the other end of the temperature measuring element is attached to a part to be measured; and
the temperature measuring element comprises a first temperature measuring element, a second temperature measuring element, and a third temperature measuring element provided in parallel with each other; wherein the first temperature measuring element is disposed in a first guide tube and a first heat-conducting component;
the second temperature measuring element is disposed in a second guide tube and a second heat-conducting component; and
the third temperature measuring element is disposed in a third guide tube and a third heat-conducting component.
